(19) United States
(12) Patent Application Publication
(10) Pub. No.: US 2018/0015618 A1
(43) Pub. Date: Jan. 18, 2018

(54) TOPOLOGICALLY AND MECHANICALLY ADAPTIVE REVERSIBLE ATTACHMENT SYSTEMS AND METHODS

(71) Applicant: Georgia Tech Research Corporation, Atlanta, GA (US)

(72) Inventors: Jason H. Nadler, Atlanta, GA (US); Michael Beckert, Atlanta, GA (US)

(21) Appl. No.: 15/650,865

(22) Filed: Jul. 15, 2017

Related U.S. Application Data
(60) Provisional application No. 62/362,633, filed on Jul. 15, 2016.

(51) Int. Cl. B25J 13/08; B25J 18/06; B65H 3/08

(52) U.S. Cl. CPC B25J 13/082; B65H 3/08; B25J 13/083; B25J 18/06

(57) ABSTRACT

The disclosed technology includes devices and methods for grasping an object. Embodiments can include a housing having an internal chamber and a face. The face can include an aperture, and the housing can be in fluid connection with a fluid displacement device. Embodiments can also include a membrane in substantially airtight connection with the housing such that the membrane encloses the aperture.

### CROSS-REFERENCE TO RELATED APPLICATIONS

This application claims priority to, and the benefit under 35 U.S.C. §119(e), of U.S. Provisional Patent Application No. 62/362,633, filed 15 Jul. 2016 and entitled “Topologically and Mechanically Adaptive Reversible Attachment System,” the entire contents and substance of which are hereby incorporated by reference as if fully set forth below.

### BACKGROUND

Various devices exist for grasping and retaining objects. Existing designs may include friction grippers or jaw grippers that generate a normal force between the gripper and an object, as well as suction grippers and magnetic grippers.

Existing designs encounter various problems in practical application. Such problems may include adaptability to objects with differing shapes, sizes, and orientations. Existing designs also lack adaptability to differing characteristics of objects such as flexibility and deformability (e.g., textiles, sheet metal), fragility and delicateness (e.g., foods, electronics such as silicon wafers or solar cells), porosity, sensitivity to static charges and/or humidity (e.g., electronics), sensitivity to liquids (e.g., electronics), and/or surface characteristics, such as slipperiness. Suction grippers, in particular, may be unable to grasp or retain an object if the outer walls of the suction device cannot form a substantially airtight seal with the object. Magnetic grippers may be used only with magnetic objects.

Some applications, such as food handling or soft tissue handling in medical applications, may carry additional contamination concerns. In contamination-prone applications, suctions grippers are typically not used because when creating suction, the suction grippers may inadvertently pull debris, bacteria, microorganisms, or other matter into the suction gripper system, which may contaminate a contamination-sensitive object in a subsequent use.

In addition, environmental aspects may inhibit the functionality of a particular design. For example, suction grippers are not typically an ideal design for submarine or vacuum environments. In submarine environments, application of suction forces may pull water into the suction generating mechanism, which may damage or contaminate the suction device. Further, as depth increases, the effectiveness of a suction attachment may decrease because of the environmental pressure. In vacuum environments, conventional suction grippers are unable to provide a sub-ambient pressure.

Thus, existing technologies are not able to sufficiently adapt to grasp and/or retain objects of varying characteristics. Existing technologies are also not able to sufficiently grasp and/or retain objects within varying environments.

### SUMMARY

The above needs and others may be addressed by certain implementations of the disclosed technology.

According to an example implementation, a grasping device can include a housing having a face and a body that defines an internal chamber. The housing can be in fluid connection with a fluid displacement device, and a membrane can be in substantially airtight connection with the housing such that the membrane encloses the aperture.

In some embodiments, the internal chamber may be a first internal chamber and the aperture may be a first aperture. The device may further comprise a second internal chamber and a second aperture. The first chamber may be in fluid connection with the first aperture and the second chamber may be in fluid connection with the second aperture. The fluid displacement device may be configured to selectively displace fluid into and/or out of the first and second chambers

In some embodiments, the device may include a mesh-like structure on the face.

In some embodiments, the mesh-like structure may be textured.

In some embodiments, the membrane may have a first thickness and a second thickness, such that the first thickness is larger than the second thickness, and portions of the membrane having the first thickness may define a grid-like structure.

In some embodiments, upon removal of fluid from the chamber by the fluid displacement device, the membrane may deform inwardly toward the housing, such that suction forces can be provided to an object in contact with the membrane.

In some embodiments, the membrane may be further operable to apply frictional forces to the object.

In some embodiments, upon transfer of fluid into the chamber by the fluid displacement device, the membrane may deform outwardly from the housing.

In some embodiments, the membrane can be composed of a material having elastic qualities.

In some embodiments, the membrane may be textured.

In some embodiments, at least a portion of the housing can be readily deformable.

In some embodiments, upon removal of fluid from the chamber by the fluid displacement device, the membrane can deform inwardly toward the housing and at least a portion of the housing can buckle and/or fold.

In some embodiments, upon removal of fluid from the chamber by the fluid displacement device, at least a portion of the housing can conform to an object being grasped by the device.

In some embodiments, the grasping device may further comprise a sensor and a processor, and the processor may be in electrical connection with the sensor and the fluid displacement device. The sensor may be operable to measure forces upon at least a portion of the housing, and upon measuring a force that exceeds a predetermined limit, the processor can cause the fluid displacement device to transfer fluid into the chamber.

According to an example implementation, a grasping device can include a mandrel that can have an internal chamber and a plurality of apertures. The mandrel can be in fluid connection with a fluid displacement device, and a membrane can be in substantially airtight connection with the mandrel such that the membrane encloses the plurality of apertures.

In some embodiments, upon transfer of fluid into the chamber, the membrane can deform outwardly and may be operable to conform to, and apply frictional forces to, a recess of an object.

In some embodiments, upon removal of fluid from the chamber, the membrane may substantially collapse and may conform to the shape of the mandrel, such that the frictional forces are removed from the recess of the object.

According to an example implementation, a method can include contacting an object with a grasping device. The grasping device can include a housing having a face and a body that defines an internal chamber. The housing can be in fluid connection with a fluid displacement device, and a membrane can be in substantially airtight connection with the housing such that the membrane encloses the aperture. The method can further include removing, from the housing and via the fluid displacement device, a portion of fluid disposed within the housing such that a negative pressure may be provided within the housing, which may cause the membrane to deform inwardly from an initial state and may provide a suction force to the object.

In some embodiments, the membrane may further provide a frictional force to the object.

In some embodiments, the method can include transferring, into the housing and via the fluid displacement device, the portion of fluid such that the negative pressure within the housing may be decreased, which may permit the membrane to return to its initial state and may remove the suction force from the object.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 depicts a schematic diagram of a grasping system, in accordance with an example embodiment of the presently disclosed technology.

FIG. 2A depicts a top view of a face of a housing, in accordance with an example embodiment of the presently disclosed technology.

FIG. 2B depicts a top view of a face of a housing, in accordance with an example embodiment of the presently disclosed technology.

FIG. 2C depicts a cross-sectional view of a housing, in accordance with an example embodiment of the presently disclosed technology.

FIG. 3A depicts a grasping system having a membrane at an initial state, in accordance with an example embodiment of the presently disclosed technology.

FIG. 3B depicts a grasping system having a membrane at a deformed state, in accordance with an example embodiment of the presently disclosed technology.

FIG. 4 depicts a textured membrane, in accordance with an example embodiment of the presently disclosed technology.

FIG. 5 depicts a membrane in an initial state and in a deformed state, in accordance with an example embodiment of the presently disclosed technology.

FIG. 6 depicts a schematic diagram of a grasping system attaching to an object, in accordance with an example embodiment of the presently disclosed technology.

FIG. 7A depicts a portion of a grasping system, in accordance with an example embodiment of the presently disclosed technology.

FIG. 7B depicts a portion of a grasping system providing suction, in accordance with an example embodiment of the presently disclosed technology.

FIG. 8 depicts a grasping system, in accordance with an example embodiment of the presently disclosed technology.

### DETAILED DESCRIPTION

Some implementations of the disclosed technology will be described more fully hereinafter with reference to the accompanying drawings. This disclosed technology may, however, be embodied in many different forms and should not be construed as limited to the implementations set forth therein.

In the following description, numerous specific details are set forth. However, it is to be understood that implementations of the disclosed technology may be practiced without these specific details. In other instances, well-known methods, structures, and techniques have not been shown in detail in order not to obscure an understanding of this description. References to “implementation”, “example implementation”, “embodiment”, and/or “example embodiment” of the disclosed technology so described may include a particular feature, structure, or characteristic, but not every implementation necessarily includes the particular feature, structure, or characteristic. Further, repeated use of the phrase “in one implementation” or “in one embodiment” does not necessarily refer to the same implementation, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described should be in a given sequence, either temporally, spatially, in ranking, or in any other manner.

Also, in describing the exemplary embodiments, terminology will be resorted to for the sake of clarity. It is intended that each term contemplates its broadest meaning as understood by those skilled in the art and includes all technical equivalents that operate in a similar manner to accomplish a similar purpose.

To facilitate an understanding of the principles and features of the present disclosure, example embodiments are explained hereinafter with reference to their implementation in an illustrative embodiment. Such illustrative embodiments are not, however, intended to be limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the disclosed technology, for example.

Embodiments of the disclosed technology include devices capable of rapid surface attachment and detachment that may be useful for a wide variety of surface topologies and surface curvatures. Some embodiments are capable of rapid surface attachment and detachment in various environmental conditions, such as submerged environments. Some embodiments of the disclosed technology grasp and/or release by displacement of a fluid within a grasping system.

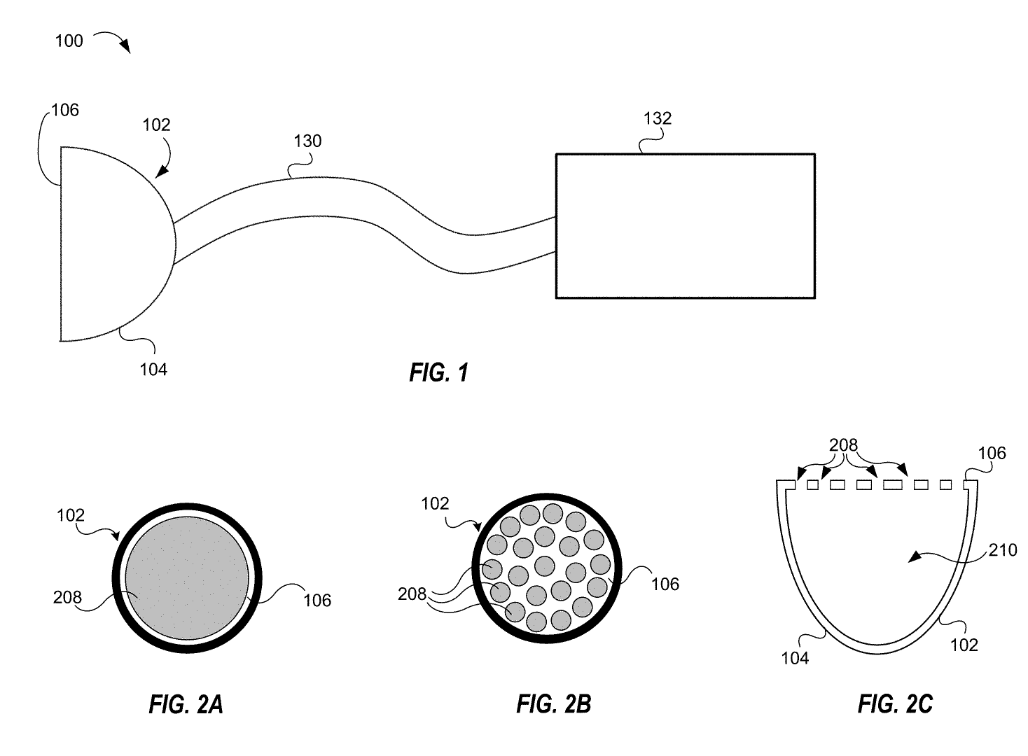

Referring to FIG. 1, certain embodiments of a grasping system 100 can include a housing 102 comprising a body 104 and a face 106. In some embodiments, the housing 102 can be hollow. In some embodiments, the housing 102 can be fluidly connected to a hose 130, and the opposite end of the hose 130 can be fluidly connected to a pump 106, plunger, or any other apparatus capable of displacing fluid (i.e., a fluid displacement device). In some embodiments, the housing 102 can be fluidly connected directly to a pump 132, plunger, or other apparatus capable of displacing fluid. According to some embodiments, the face 106 may have one or more apertures. Some embodiments can have a single aperture 208, such as the embodiment shown in FIG. 2A, while other embodiments can have a plurality of apertures 208, such as the embodiment shown in FIG. 2B. The apertures 208 may be of any suitable shape including, but not limited to, a circle, oval, crescent, square, rectangle, triangle, hexagon, octagon, parallelogram, and rounded versions of polygons. Referring to FIG. 2C, a substantially hollow chamber 210 can be defined within the housing 102, and the chamber 210 can be in fluid connection with the one or more apertures 208 and the hose 130 and/or pump 132. In some embodiments, a plurality of chambers 210 may be defined within the housing 102, and in some embodiments a separate chamber 210 may be in independent fluid connection with each respective aperture 208 or a group of apertures 208.

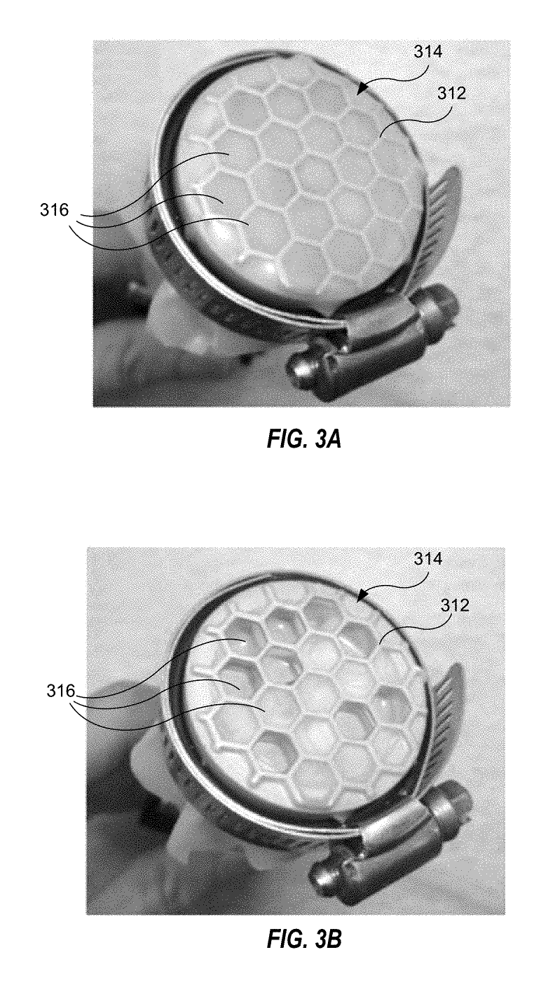

Referring to FIGS. 3A and 3B, some embodiments can include a raised mesh 312 that defines and/or aligns with the plurality of apertures 208. The mesh 312 may be a separate part that is attached, affixed, or connected to the housing 102 and/or the face 106, or the mesh 312 may be integral with the housing 102. The apertures 208 and/or the mesh 312 may be arranged in any desired pattern, such as a hexagonal grid, a square grid, a series of concentric rings (e.g., the pattern shown in FIG. 2B), or any other suitable pattern.

Certain embodiments can include a membrane 314 disposed across the face 106 of the housing 102. In some embodiments, the membrane 314 may be in substantially airtight connection with the housing 102, and in certain embodiments, the membrane 314 may be in substantially airtight connection with the face 106 and/or the mesh 312 such that one or more displaceable regions 316 are defined. In addition to other benefits which will become apparent, the membrane 314 may permit the grasping system 100 to utilize fluid displacement to grasp and/or retain objects while preventing the introduction of foreign contaminants into the interior of the grasping system 100. As mentioned previously, certain embodiments may comprise a plurality of chambers 210. In some embodiments, each chamber 210 may be in separate and independent fluid connection with a respective displaceable region 316 or a group of displaceable regions 316, and each chamber 210 may be in fluid connection with a pump 132, such that each displaceable region 316 can be independently controlled.

According to some embodiments, the body 104 may have a parabolic or hemispheric shape, resembling a cup or a bowl. In some embodiments, the body 104 may be of any suitable shape including but not limited to a cylinder, a box, and a sphere. In some embodiments, the body 104 may be made of a substantially rigid material or a combination of substantially rigid materials, such as metals, metal alloys, and structural plastics. In certain embodiments, the body 104 may be made of a substantially deformable material or a combination of substantially deformable materials, such as silicone, urethane and neoprene. In some embodiments, the body 104 may be designed to collapse such that it may fold into a more compact form. In some embodiments, the body 104 may be designed to collapse and/or buckle about an object as the grasping system 100 engages the object, which may facilitate grasping or clamping of the object.

While the face 106 is depicted as having a generally circular shape, the face 106 may be of any suitable shape including, but not limited to, oval, crescent, square, rectangle, triangle, hexagon, octagon, parallelogram, and rounded versions of various polygons. In some embodiments, the surface of the face 106 may be flat or curved (e.g., concave, convex). Certain embodiments may have a simple topology (e.g., spherical, cylindrical) or a complex topology. The face 106 and/or the mesh 312 may be porous, rough, or otherwise structured, which may allow for the porous, rough, or otherwise textured and/or patterned surface of the face 106 and/or mesh 312 to become imparted to the membrane 314 during some or all of the grasping process. This may assist in imparting frictional forces to the object, which may assist in attaching, grasping, and/or retaining the object.

The size of various embodiments may be scaled according to a specific application and/or environment. Some embodiments may include a face 106 having a surface area of approximately 1 cm² to approximately 10 cm². Some embodiments may include a face 106 having a surface area of approximately 10 cm² to approximately 100 cm². Some embodiments may include a face 106 having a surface area of approximately 100 cm² to approximately 500 cm² or even 500 cm² to 1000 cm². These dimensions are merely illustrative, and a person of skill in the art will realize that embodiments smaller or larger may be useful, as required or needed.

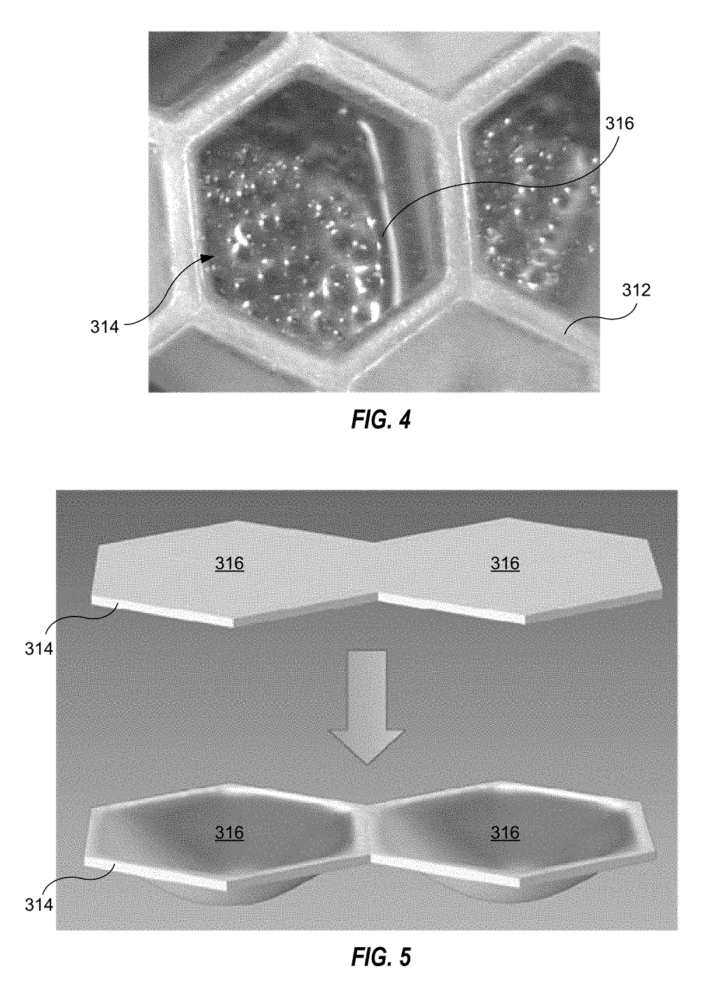

In certain embodiments, the membrane 314 may be composed of any suitable elastomer and/or rubber-like material, including but not limited to silicone, latex, urethane, and neoprene. In some embodiments, the membrane 314 may be permeable to fluids, and in some embodiments, the membrane 314 may be impermeable to fluids. In some embodiments, the membrane 314 may be a single material, and in some embodiments, the membrane 314 may be a composite material or a functionally graded materials system. In certain embodiments, the membrane 314 may have a thickness in the range of approximately 0.1 mm to approximately 1 mm, approximately 1 mm to approximately 3 mm, approximately 3 mm to approximately 5 mm, or approximately 5 mm to approximately 10 mm. These ranges are for illustrative purposes only; persons of skill in the art will realize that a suitable membrane thickness is at least partly dependent on the material composing the membrane 314, as well as ambient pressure and the performance capabilities of the pump 132, plunger, or other fluid displacement device. Accordingly, some embodiments may comprise a membrane 314 having a thickness less than 0.1 mm, and some embodiments may comprise a membrane 314 having a thickness greater than 10 mm. In some embodiments, the thickness of the membrane 314 may be substantially uniform. Some embodiments may comprise a membrane 314 having a smooth surface. In certain embodiments, such as the embodiment shown in FIG. 4, the surface of the membrane 314 can be textured and/or patterned, which may enhance the frictional contact made between the membrane 314 and the object. In some embodiments, the membrane may become textured and/or patterned by some or all of the face 106 and/or the mesh 312.

According to some embodiments, the thickness of the membrane 314 may be locally reduced in certain areas, resulting in thicker areas and thinner areas that have a comparatively reduced stiffness and/or rigidity as compared to the thicker areas. In some such embodiments, the thicker areas may define shapes and/or textures similar to that which can be provided by the mesh 312. Some embodiments may use both a mesh 312 and a membrane 314 having thicker areas and thinner areas.

In some embodiments, the interior of the grasping system, which may include the chamber 210, may hold a quantity of fluid. The fluid may be gaseous, such as air, or may be liquid, such as water. Embodiments of the disclosed technology, however, are not limited to air and water; certain embodiments may include other suitable types of liquids and gases. As the pump 132 displaces the fluid, attachment and detachment (i.e., grasping and releasing) to an object may be achieved. For example, in some embodiments, the pump 132 can remove fluid from the chambers 210, providing a negative pressure to the displaceable regions 316 and causing the displaceable regions 316 to deform inwardly, which can provide suction forces and/or friction forces to the object. Referring to FIG. 5, the upper portion of the figure depicts a membrane 314 at rest. As negative pressure is provided to the chambers 210, the membrane 314 can deform inwardly at the displaceable regions 316, as shown in the lower portion of FIG. 5. In some embodiments, the membrane 314, the face 106, and/or the mesh 312 may be structured such that the interface between the displaceable regions 316 and the object resists the flow of fluid into the concave recesses of the displaceable regions 316 that form when the displaceable regions 316 deform inwardly. In some embodiments, this may be at least in part due to the relative stiffness of the mesh 312 as compared to the membrane 314.

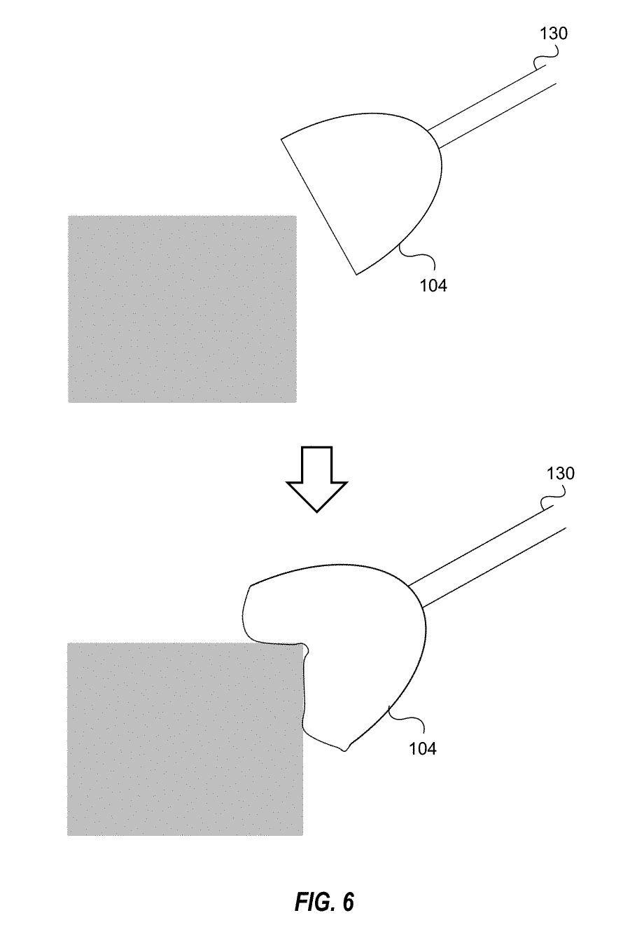

In certain embodiments, removal of fluid from the chambers 210 may cause the membrane 314, the face 106, the mesh 312, and/or the body 104 to slightly deform inward such that a portion of the object is received in the inward deformation, which may impart frictional forces on the surface of the object. In some embodiments, such as the embodiment shown in FIG. 6, application of negative pressure to the chambers 210 may cause the membrane 314, the face 106, the mesh 312, and/or the body 104 to buckle or otherwise deform to at least partially conform to the topology of the object such that the grasping system 100 can apply frictional forces to the object. Thus, according to some embodiments, the object may be grasped and/or retained via some combination of suction forces and frictional forces. The frictional forces may increase the resistance to shearing motions between the grasping system 100 and the object and/or may increase the overall adhesion of the grasping system 100 to the object by imparting frictional forces in addition to the suction force imparted by the negative pressure at the displaceable regions 316. This may be especially useful in vacuum environments, where suction is not possible; in vacuum environments, attachment may depend on frictional force and/or Van der Waals forces.

As previously discussed, some embodiments may be configured to selectively and independently control some or all displaceable regions 316. Some embodiments may periodically displace an amount of fluid within a particular chamber 210 to reestablish or maintain attachment conditions at or near the interface between a respective displaceable region 316 and the object. In some embodiments, the period displacement may be localized. In certain embodiments, the periodic displacement may be propagated at various displaceable regions 316, which may provide a sweeping wave motion or similar motions.

To release an object, the pump 132 may reintroduce the fluid into the chambers 210, which may facilitate detachment and/or release of the object. The pump 132 may introduce additional fluid into the chambers 210, which may cause the membrane 314, the face 106, and/or the mesh 312 to deform outwardly, which may assist in clearing residual fluid and/or particulate from the outer surface of the membrane 314.

Some embodiments may provide an attachment fluid to the outer side of the membrane 314, which may enhance attachment performance. The desirability or need of such a fluid may be dependent on the object being grasped and/or retained. Some embodiments may include a quantity of attachment fluid that may be dispensed from or near the face 106. The attachment fluid may be a fluid having Newtonian, shear-thickening, or shear-thinning viscosity behaviors.

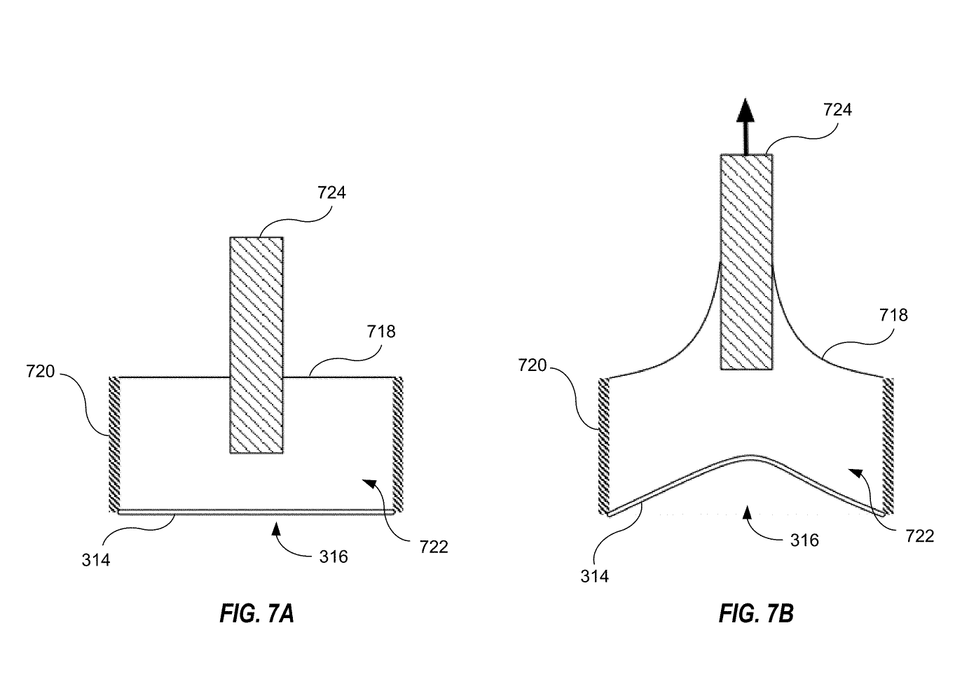

Referring to FIGS. 7A and 7B, certain embodiments can comprise an elastomer layer 718 that is spaced apart from the membrane 314 by a comparatively rigid structure 720. In some embodiments, the rigid structure 720 can be the face 106, the mesh 312, relatively thicker portions of the membrane 314 (as discussed above), and/or any other structure having a sufficient rigidity. The membrane 314 and the elastomer layer 718 may be in substantially airtight connection with the rigid structure 720 such that the membrane 314, the elastomer layer 718, and the rigid structure 720 form a void 722. In some in embodiments, the void 722 may comprise any suitable fluid. In certain embodiments, the elastomer layer 718 can be connected to an arm 724. In some embodiments and as depicted in FIG. 7B, pulling the arm 724 away from the rigid structure 720 can pull the elastomer layer 718, providing negative pressure to the membrane 314 via the fluid in the void 722. In turn, this can cause the membrane 314 to deform inwardly, providing suction forces to an object in contact with the membrane 314. Conversely, in some embodiments, pushing the arm 724 toward the rigid structure 720 may push the elastomer layer 718, providing positive pressure to the membrane 314 via the fluid in the void 722, which may cause the membrane 314 to deform outwardly. Embodiments including an elastomer layer 718 may provide an additional layer of protection against leaks and/or contaminants in the event that the membrane 314 tears, ruptures, or is otherwise damaged. Additionally, such embodiments may provide some retained efficacy of the grasping system 100 if the membrane tears, ruptures, or is otherwise damaged in one or more displaceable regions 316, provided the membrane 314 remains intact in at least one displaceable region 316.

In some embodiments, the arm 720 can be composed of metals, metal alloys, structural plastics, or any other material of suitable rigidity. In some embodiments, the arm 720 is composed of any material capable of transferring and/or enduring tension, such that the arm 720 may apply pull forces to the elastomer layer 718. In certain embodiments, the elastomer layer 718 may be composed of any suitable elastomer and/or rubber-like material, including but not limited to silicone, latex, urethane, and neoprene. In some embodiments, the elastomer layer 718 may be a single material, and in some embodiments, the elastomer layer 718 may be a composite material or a functionally graded materials system. In some embodiments, the elastomer layer 718 may be composed of the same material or materials as the membrane 314, and in some embodiments, the elastomer layer 718 may be composed of a different material or materials. In certain embodiments, the elastomer layer 718 may have a thickness in the range of approximately 0.1 mm to approximately 1 mm, approximately 1 mm to approximately 3 mm, approximately 3 mm to approximately 5 mm, or approximately 5 mm to approximately 10 mm. These ranges are for illustrative purposes only; persons of skill in the art will realize that a suitable elastomer layer thickness is at least partly dependent on the material composing the elastomer layer 718, as well as the expected forces that will be provided to the elastomer layer 718.

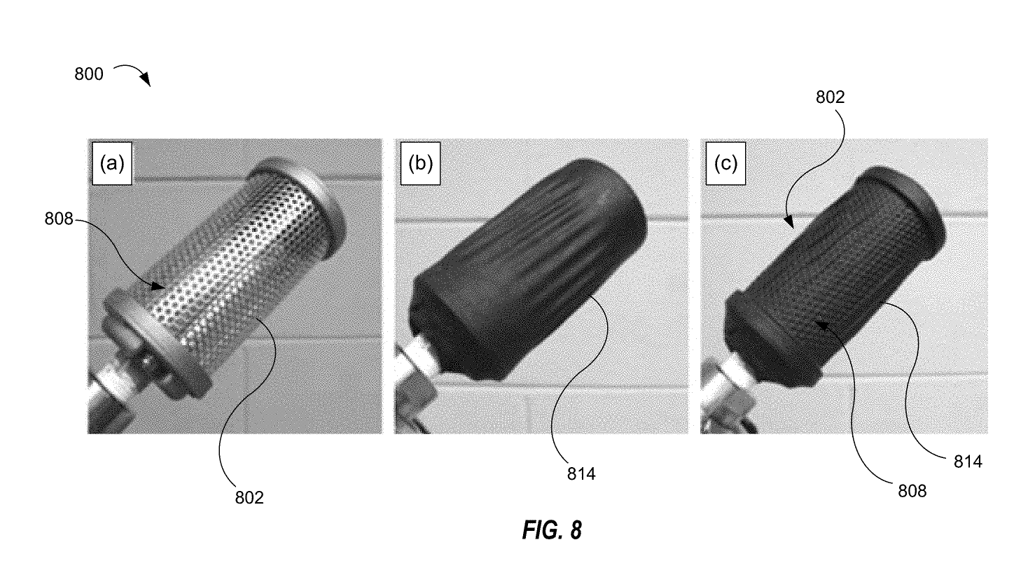

Referring to pane (a) of FIG. 8, certain embodiments of the grasping system 800 may include a relatively rigid and substantially hollow mandrel 802. The mandrel 802 may include a plurality of apertures 808, and the membrane 814 may be in substantially airtight connection with the mandrel 802 while covering all of the apertures 808, as shown in pane (b) of FIG. 8. The pump 132 may remove an amount of fluid from the mandrel 802 such that the membrane 814 substantially conforms to the structure of the mandrel 802. To grasp an object having a recess, the mandrel 802 can be inserted into the recess, and the pump 132 can displace fluid into the mandrel 802. The fluid being introduced into the mandrel 802 can escape through the apertures 808 such that the membrane 814 expands and/or deforms outwardly from the mandrel 802. As the membrane 814 deforms outwardly, it may substantially fill the recess of the object, such that the object can be grasped and/or retained by frictional forces between the membrane 814 and the recess of the object. In certain embodiments, the mandrel 802 may be composed of a deformable material such that it can at least partially conform to recesses of objects while retaining its basic shape. This may increase the depth of penetration into the recess of an object, which may increase the frictional forces and the strength of the hold. To release the object, the pump 132 may displace fluid from the mandrel 802 and membrane 814 such the membrane 814 can return the shape of the mandrel 802, thus permitting the grasping system 800 to be removed from the recess of the object.

Some embodiments may include a processor and a sensor capable of sensing and/or measuring force magnitude. The sensor and processor may be operable to prevent the grasping system from applying force beyond a predetermined limit, which may protect the object and/or the grasping system from potential damage. In some embodiments, upon sensing a predetermined force limit has been exceeded, the processor may direct the grasping system to release the object and/or return the object to its original position. Some embodiments may include an active control system comprising sensors and a processing device, and the processing device may be configured to increase or decrease the duration and/or selectively attach and detach portions of the grasping system. For example, the processing device may calculate that an object would be held more securely if certain of the displaceable regions of the membrane were provided an increase of negative pressure, and the processing device may send instructions to the appropriate pumping devices to provide an increase of negative pressure to the respective displaceable regions. As another example, an object may be stuck or too heavy for a specific embodiment. To prevent damage to the grasping system, a sensor may indicate that the grasping system is pulling beyond a predetermined pull limit, and in response, the processing device may direct the grasping system to release the object and/or return the object to its original position (or nearby). As yet another example, to prevent damage to fragile objects, a sensor may indicate that the grasping system is providing force to the object beyond a predetermined limit, and in response, the processing device may direct the grasping system to decrease the amount of force applied to the object.

Certain embodiments may include a drag force harvesting device that may be operable to harvest viscous shear forces and/or drag forces that result when the grasping system 100, 800 is attached to a object moving at a sufficient speed. In some embodiments, the harvested forces may converted into electricity to store power in a battery or capacitor. In certain embodiments, the harvested forces may be converted into electricity and/or converted into stored mechanical energy (e.g., by a spring) to assist in sustaining the membrane 314 at a deformed position or to assist in providing power to the pump 132, plunger, fluid displacement device, arm 710, or other device or mechanism used to displace the membrane 314. In some embodiments, the harvested forces may be used by a fluidic circuit in the grasping system 100, 800, which may assist in achieving a preferred membrane displacement and/or orientation and/or stepwise, localized displacement of the membrane 314. In certain embodiments, the drag force harvesting device may be operable to harvest viscous shear forces and/or drag forces occurring in a range of directions from parallel to the face 106 (or any other particular part of the grasping system 100, 800) to perpendicular to the face 106.

While certain implementations of the disclosed technology have been described in connection with what is presently considered to be the most practical implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A grasping device comprising:
a housing having (i) a body defining an internal chamber and (ii) a face, the face comprising an aperture and the housing being in fluid connection with a fluid displacement device; and
a membrane in substantially airtight connection with the housing such that the membrane encloses the aperture.

2. The grasping device of claim 1, wherein the internal chamber is a first internal chamber and the aperture is a first aperture, the device further comprising a second internal chamber and a second aperture,
wherein the first chamber is in fluid connection with the first aperture and the second chamber is in fluid connection with the second aperture,
wherein the fluid displacement device is configured to selectively displace fluid into and/or out of the first and second chambers.

3. The grasping device of claim 1, further comprising a mesh-like structure on the face.

4. The grasping device of claim 3, wherein the mesh-like structure is textured.

5. The grasping device of claim 1, wherein the membrane has a first thickness and a second thickness, the first thickness being larger than the second thickness, and wherein portions of the membrane having the first thickness define a grid-like structure.

6. The grasping device of claim 1, wherein upon removal of fluid from the chamber by the fluid displacement device, the membrane deforms inwardly toward the housing, such that suction forces can be provided to an object in contact with the membrane.

7. The grasping device of claim 6, wherein the membrane is further operable to apply frictional forces to the object.

8. The grasping device of claim 1, wherein upon transfer of fluid into the chamber by the fluid displacement device, the membrane deforms outwardly from the housing.

9. The grasping device of claim 1, wherein the membrane is composed of a material having elastic qualities.

10. The grasping device of claim 1, wherein the membrane is textured.

11. The grasping device of claim 1, wherein at least a portion of the housing is deformable.

12. The grasping device of claim 1, wherein upon removal of fluid from the chamber by the fluid displacement device, the membrane deforms inwardly toward the housing and at least a portion of the housing buckles and/or folds.

13. The grasping device of claim 12, wherein upon removal of fluid from the chamber by the fluid displacement device, at least a portion of the housing conforms to an object being grasped by the device.

14. The grasping device of claim 1, further comprising a sensor and a processor, the processor in electrical connection with the sensor and the fluid displacement device,
wherein the sensor is operable to measure forces upon at least a portion of the housing, and upon measuring a force that exceeds a predetermined limit, the processor causes the fluid displacement device to transfer fluid into the chamber.

15. A grasping device comprising:
a mandrel having an internal chamber and a plurality of apertures, the mandrel being in fluid connection with a fluid displacement device; and
a membrane in substantially airtight connection with the mandrel such that the membrane encloses the plurality of apertures.

16. The grasping device of claim 15, wherein upon transfer of fluid into the chamber, the membrane deforms outwardly and is operable to conform to, and apply frictional forces to, a recess of an object.

17. The grasping device of claim 16, wherein upon removal of fluid from the chamber, the membrane substantially collapses and conforms to the shape of the mandrel, such that the frictional forces are removed from the recess of the object.

18. A method comprising:
contacting an object with a grasping device, the grasping device comprising:
a housing having (i) a body defining an internal chamber and (ii) a face, the face comprising an aperture and the housing being in fluid connection with a fluid displacement device, and
a membrane in substantially airtight connection with the housing such that the membrane encloses the aperture; and
removing, from the housing and via the fluid displacement device, a portion of fluid disposed within the housing such that a negative pressure is provided within the housing, causing the membrane to deform inwardly from an initial state and providing a suction force to the object.

19. The method of claim 18, wherein the membrane further provides a frictional force to the object.

20. The method of claim 18 further comprising transferring, into the housing and via the fluid displacement device, the portion of fluid such that the negative pressure within the housing is decreased, permitting the membrane to return to its initial state and removing the suction force from the object.
